(19) United States
(12) Patent Application Publication
(10) Pub. No.: US 2017/0120703 A1
(43) Pub. Date: May 4, 2017

(54) TIRE HAZARD ALERTING SYSTEM

(71) Applicants: Nigel Andrews, Ipswich (AU); Martin Smith, Ipswich (AU)

(72) Inventors: Nigel Andrews, Ipswich (AU); Martin Smith, Ipswich (AU)

(21) Appl. No.: 15/336,677

(22) Filed: Oct. 27, 2016

Related U.S. Application Data
(60) Provisional application No. 62/248,137, filed on Oct. 29, 2015.

(51) Int. Cl. B60C 25/05; B60C 25/00

(52) U.S. Cl. CPC B60C 25/0557; B60C 25/002; B60C 25/0551

(57) ABSTRACT

Systems for detecting and monitoring tire pressure and temperature during a tire repair or replacement procedure are provided. The systems are configured to communicate a warning signal to a plurality of individuals (e.g., tire maintenance personnel) upon the tire pressure or temperature exceeding a defined threshold (e.g., upon the tire pressure or temperature entering a dangerous range). The system generally includes three categories of components, namely, components associated with a truck (or large work machine) and the tire being analyzed; a tire handler component; and a device that is worn (or held) by tire maintenance personnel, with such components being configured to wirelessly communicate with each other.

### CROSS-REFERENCE TO RELATED APPLICATIONS

This application claims priority to U.S. provisional patent application Ser. No. 62/248,137, filed Oct. 29, 2015.

### FIELD OF THE INVENTION

The field of the present invention relates to systems and methods for warning personnel working in close proximity to a tire (or tires) where the pressure and/or temperature within a tire has exceeded a defined threshold and, therefore, represents a safety hazard.

### BACKGROUND OF THE INVENTION

Inflatable tires that are used in connection with trucks and large work machines, such as those used in the construction, excavation, and mining industries, require occasional maintenance, repair, and/or replacement. As with standard automotive tires, the tires that are used in connection with trucks and large work machines should exhibit an internal air pressure and temperature within a preferred range, to maximize the functionality and durability of such tires. There have been instances, however, when the temperature and internal pressure of such tires, when being serviced by workers, has unknowingly escalated above a safety threshold (or elevated pressure still remains in a tire being deflated). In some cases, the tires have exploded due to excessive air pressures and/or temperature, which has resulted in serious bodily harm to those in proximity of the tire.

Accordingly, there is a continuing need in the marketplace for systems that are configured to monitor the temperature and pressure within such tires—and preferably issue a warning notice to those in proximity of the tires in the event that the pressure and/or temperature of the tire exceeds a safety threshold. As the following will demonstrate, the systems of the present invention address such needs in the marketplace.

### SUMMARY OF THE INVENTION

According to certain aspects of the invention, systems for detecting and monitoring tire pressure and temperature during a tire repair or replacement procedure are provided. The systems of the present invention are configured to communicate a warning signal to a plurality of individuals (e.g., tire service personnel) upon the tire pressure or temperature exceeding a defined (safety) threshold. The systems generally include a third party tire pressure monitoring system (TPMS) interface unit, which is configured to continually monitor temperature and pressure data associated with a tire being repaired or replaced, along with other components of the system (described below) that are configured to wirelessly issue warning signals to the tire service personnel working on the vehicle or machine (when tire pressure and/or temperature exceeds a defined threshold).

More particularly, the systems further include a proximity detection system (PDS) that is configured to detect, monitor, and wirelessly communicate a location of individuals (tire maintenance workers/personnel) who are wearing a personal proximity device (PPD). The systems of the present invention further include a tire handler component that includes an omnidirectional head unit (OHU). The tire handler component is configured to receive temperature and pressure data from the tire pressure monitoring system (TPMS) interface unit, along with proximity information from the proximity detection system (PDS). The invention provides that the tire handler component is further configured to wirelessly communicate with each personal proximity device (PPD) to alert a person wearing such device (a) if they are within a defined radius of the tire handler or (b) if the temperature or pressure data associated with the tire being repaired or replaced falls within a defined warning range (based on data provided by the TPMS interface unit).

In certain preferred embodiments, the system is configured to issue at least three different signals to each personal proximity device (PPD). For example, a first signal may indicate that tire pressure and temperature are within a pre-defined normal range; a second signal may indicate that tire pressure and temperature are outside of a pre-defined normal range (i.e., the pressure and temperature data are within a dangerous range); and a third signal may indicate that an individual wearing a personal proximity device (PPD) is within a defined radius of the tire handler. Still further, the invention provides that the system is further configured to provide a steady stream of feedback data, which informs an operator that the system is working and correctly monitoring the tire being repaired or replaced.

The above-mentioned and additional features of the present invention are further illustrated in the Detailed Description contained herein.

### BRIEF DESCRIPTION OF THE DRAWINGS

FIG. 1 is a diagram that illustrates the architecture and various components of the system described herein.

FIG. 2 is a non-limiting example of a graphical user interface of the tire handler operator control panel described herein, in which the TPMS module is being selected.

FIG. 3 is a non-limiting example of a graphical user interface of the tire handler operator control panel described herein, in which a specific truck is being selected.

FIG. 4 is a non-limiting example of another graphical user interface of the tire handler operator control panel described herein, in which a specific truck is being selected.

FIG. 5 is a non-limiting example of a graphical user interface of the tire handler operator control panel described herein, in which a tire to be serviced is selected by the operator.

FIG. 6 is a non-limiting example of a graphical user interface of the tire handler operator control panel described herein, in which TPMS settings are established by authenticated and authorized operators of the system.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

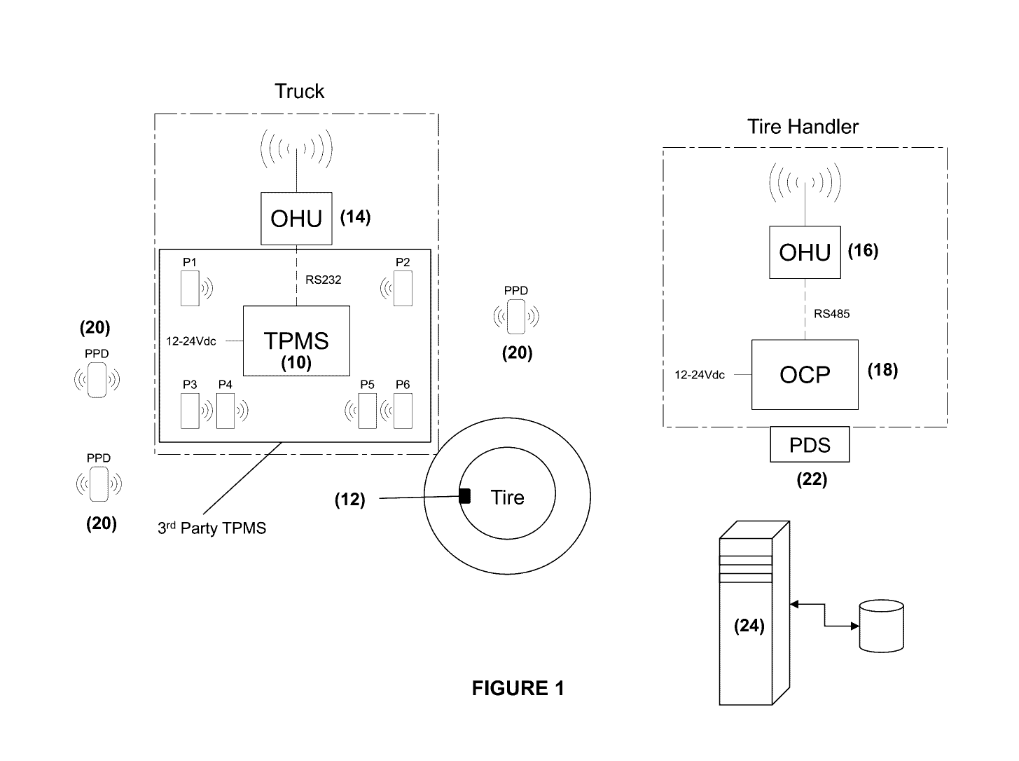

Referring now to FIGS. 1-4, the system of the present invention generally includes three categories of components, namely, components associated with a truck (or large work machine); a tire handler component; and a device that is worn (or held) by a tire maintenance person. Each of these three components will be described below, followed by a description of the means by which such components operate and communicate with each other within the context of the system.

Truck Components

The system includes a tire pressure monitoring system (TPMS) interface unit (10), which is configured to continually monitor and wirelessly communicate the interior temperature and pressure of each tire being analyzed by the system. The invention provides that the TPMS interface unit (10) is also configured to wirelessly communicate with a proximity detection system (PDS) (22) via a RS232 serial port. The proximity detection system (PDS) (22) is configured to monitor and report a location of each individual (i.e., a tire maintenance person), who is wearing a personal proximity device (PPD) (20) described below. The PDS may detect and monitor the location of each such individual via, for example, global positioning satellite (GPS) technology. The TPMS interface unit (10) is also configured to remotely and wirelessly communicate with a TPMS website server (24) via a 3G modem. The TPMS website server (24) is configured to host and publish a website (or intranet site) through which TPMS settings are established and TPMS data may be viewed, as described herein.

The system further includes tire sensors (12), which are configured to wirelessly communicate tire pressure and temperature data to the TPMS interface unit (10). The tire sensors (12) are configured to be magnetically affixed or glued to the inside of each tire (e.g., onto the rim of the tire). The sensors (12) are preferably replaced each time that a tire is serviced, repaired, or replaced. Furthermore, the system is preferably configured in a way to allow the sensors (12) to be changed during tire maintenance, while continuing to provide the safety alerts described herein. For example, a new sensor (12) may be installed and affixed to a tire, before a pre-existing/older sensor (12) is removed from the same tire. This way, between the new and old sensors (12), the TPMS interface unit (10) will receive an uninterrupted stream of tire pressure and temperature data.

The truck portion of the system further includes an omnidirectional head unit (OHU) (14), which is configured to wirelessly communicate the status of the truck tire pressure monitoring system (TPMS) with the proximity detection system (PDS) (22) of the tire handler through a wireless data link, e.g., through a 900 Mhz spread spectrum radio frequency. The wireless data links used in the system may also consist of any one or more transmitters/receivers using either ISM band/free to air devices, wireless modems, WiFi, Zigbee, dedicated radio frequency (RF) channels, or other wireless data devices.

Tire Handler

The tire handler component also includes an omnidirectional head unit (OHU) (16), which is configured to communicate with the truck TPMS (10) and the personal proximity devices (PPDs) (20) described herein, via a wireless data link. The tire handler further includes an operators control panel (OCP) (18), which provides the operator with a graphical display of the trucks and machines within close proximity of the tire handler, and is configured to warn the operator if he/she a truck or machine that is too close to (i.e., is within a defined radius of) a worker wearing a personal proximity device (PPDs) (20). The invention provides that the tire handler omnidirectional head unit (OHU) (16) is configured to communicate with the operators control panel (OCP) (18) via an RS485 serial port, such that the system information and alerts may be visually displayed to an operator. Still further, the invention provides that the operators control panel (OCP) (18) is preferably configured to display tire pressure and temperature data, allow alarm set-points to be adjusted (as described further below), and to allow an operator to select the truck or machine that will be serviced within an intuitive graphical user interface (so that the temperature and pressure of the appropriate tires can be actively monitored).

Tire Maintenance Person Device

The system further includes personal proximity devices (PPDs) (20), which are configured to be worn (or held) by tire maintenance personnel. The PPDs (20) are configured to alert such person if they come too close to (i.e., within a defined radius of) a tire handler. Still further, the PPDs (20) are configured to alert such person if a tire being repaired or serviced exhibits a temperature or pressure above a pre-defined safety threshold.

System Functionality

The following describes the means by which the system operates during tire maintenance, repair, and/or replacement to protect tire maintenance persons who perform such work. In certain preferred embodiments, the invention provides that the tire handler operators control panel (OCP) (18) is used to enable (or disable) the system and to warn the maintenance persons engaged in a tire service or replacement if an unsafe condition develops (as described further below). The invention provides that, since the system is configured to continuously monitor the truck TPMS (10) during a tire maintenance, repair, and/or replacement, both the truck TPMS (10) and the tire handler component should be continuously powered during such procedures. To that end, in certain embodiments, the truck TPMS (10) and the tire handler component may comprise an internal battery (power source) to ensure that such components are continuously operational.

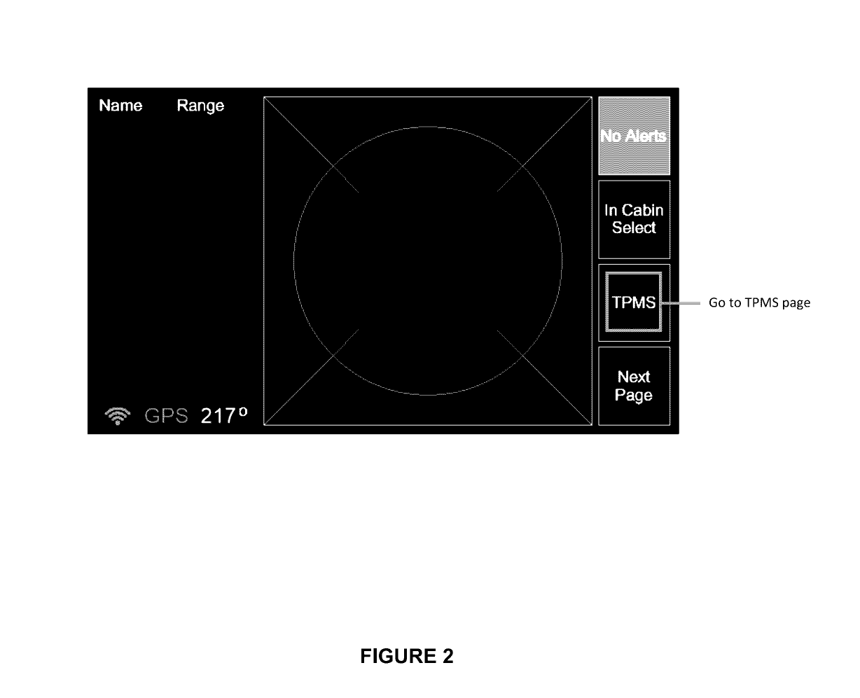

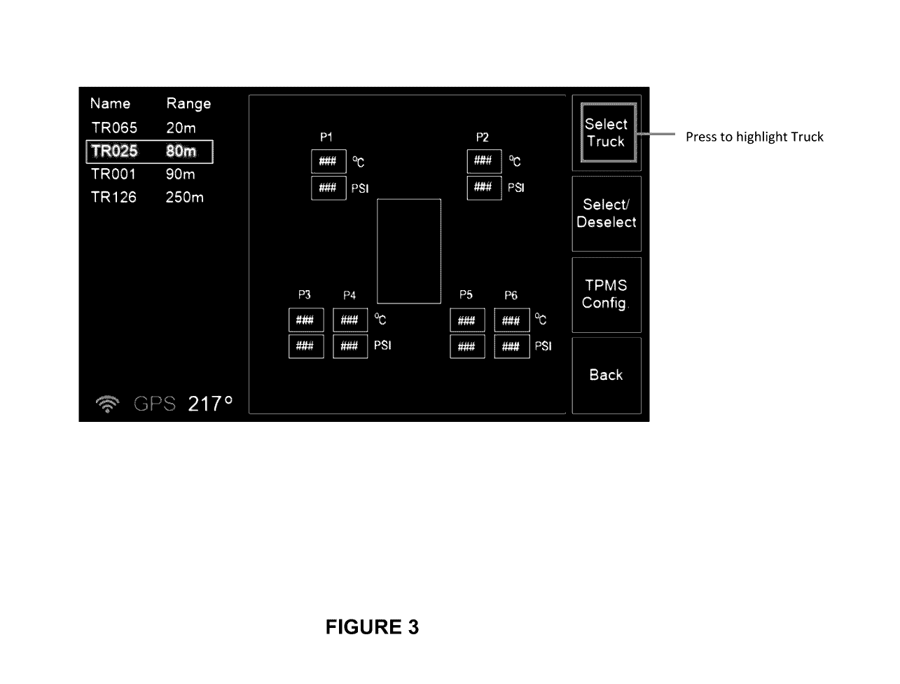

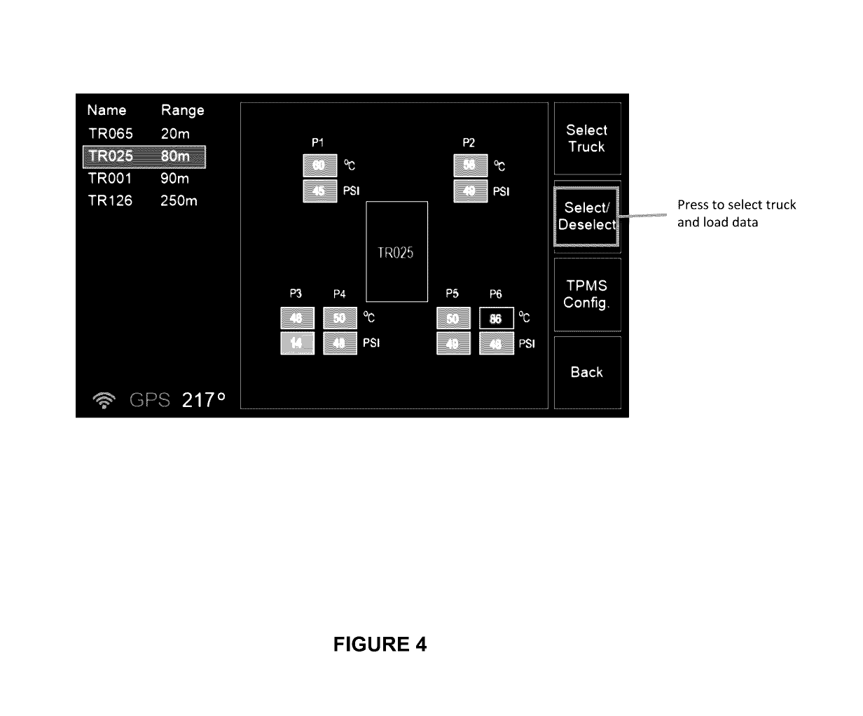

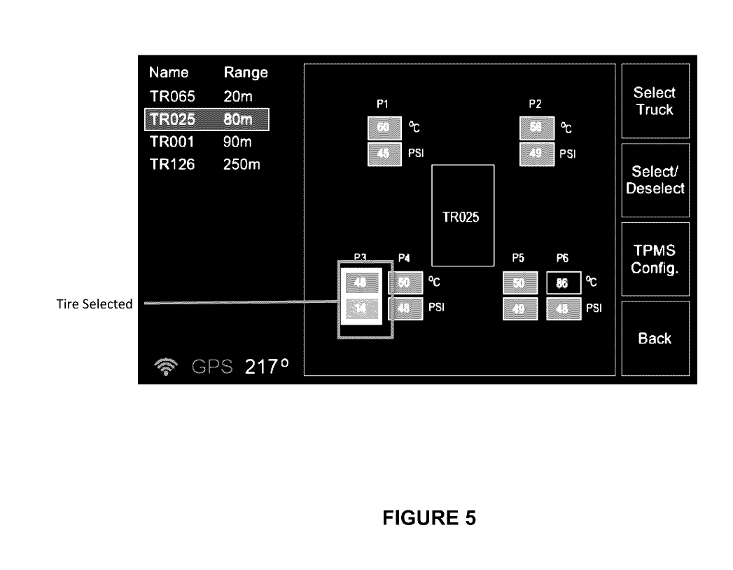

The invention provides that tire maintenance, repair, and/or replacement may begin when an operator activates the applicable truck TPMS (10) within a main page of the tire handler operators control panel (OCP) (18), e.g., by selecting a TPMS option within the graphical user interface. See, e.g., FIG. 2. Next, the operator may select the truck that will be the subject of tire maintenance, repair, and/or replacement within such interface. See, e.g., FIG. 3 and FIG. 4. In addition, as illustrated in FIG. 5, the operator may then select the specific tire that will be serviced or replaced, e.g., by selecting the appropriate tire icon within the tire handler operators control panel (OCP) (18). The invention provides that the applicable TPMS (10) should then be enabled and a selected truck identifier will preferably be displayed inside the truck icon of such graphical user interface, which confirms that the truck has been selected.

The invention provides that the tire pressure and temperature information will then be retrieved from the tire(s) via the tire sensors (12), and displayed in the applicable location of the graphical user interface. Depending on the temperature and pressure set-points that have been prescribed (as discussed below), the tire sensors (12) may be displayed in different colors according to the detected pressure and temperatures states (or other visual insignia may be used to denote the detected pressure and temperatures states), as illustrated in the exemplary table below (which lists non-limiting examples of default set-points).

TABLE 1

| State | Pressure (PSI) | Temperature (° C.) |
|---|---|---|
| Service | 0-89 | — |
| (Yellow) | | |
| Normal | 90-110 | 0-70 |
| (Green) | | |
| Caution | 111-130 | 71-85 |
| (Orange) | | |
| Danger | >130 | >86 |
| (Red) | | |

Once a tire has been selected within the operators control panel (OCP) (18), as illustrated in FIG. 5, the invention provides that the personal proximity devices (PPDs) (20) worn by the tire maintenance persons will begin to emit a signal. This signal communicates to all tire maintenance persons that a tire is currently and actively being serviced. A non-limiting example of a signal may consist of an audible “beep” sound (in other embodiments, the signal may take the form of an abbreviated PPD vibration which the tire maintenance persons can feel). The signal will communicate certain information to the person wearing the applicable PPD, which is correlated with the detected status of the TPMS. A non-limiting set of signals in summarized in the table below.

TABLE 2

| State | Description | Signals |
|---|---|---|
| Normal | System operating normally in proximity | No beeps |
| | detection mode. | |
| TPMS | (i) System operating normally in TPMS mode | 1 beep per |
| Caution | with valid data being received from the | 5 seconds |
| | TPMS. | |
| | (ii) All tire pressures and temperatures are | |
| | within a defined normal range. | |
| | (iii) The selected tire pressure and temperature | |
| | are equal to or below the defined service | |
| | value. | |
| TPMS | (i) Any tire pressure or temperature is equal to | 2 beeps per |
| Warning | or exceeds a defined caution or danger | 5 seconds |
| | range/threshold. | |
| | (ii) The selected tire pressure and temperature | |
| | is greater than the service value. | |
| PDS | Tire maintenance person is too close to a | 2 beeps per |
| Warning | selected/serviced tire (within a defined radius | second |
| | of the serviced tire). | |

The example signals in Table 2 above are derived from TPMS data, with the defined set points having been entered into a TPMS configuration page. When the TPMS is enabled (i.e., a truck has been selected), the proximity detection system (PDS) (22) requests the TPMS pressure and temperature data from the applicable sensors (12), along with related time and date stamp data. The PDS system (22) first checks the integrity of such data, and then compares the age of the data with its own real-time clock and, if they are within an acceptable (pre-defined) limit or range, the data are displayed and a valid data flag is set. The PPD (22) will then begin emitting signals, as exemplified in Table 2 above.

The invention provides that the system is also preferably configured to provide a steady stream of feedback data, which informs an operator that the system is working and actively monitoring a particular truck TPMS (when selected), and that the information being received is valid. More particularly, for example, the invention provides that the PDS system (22) is configured to continually check the TPMS data that it receives and, if such data are not valid, the values are designated in the user interface as invalid (e.g., the data will be hashed out) and a PPD “caution” or “warning” signal will stop. In such case, the tire maintenance persons should revert to normal operating procedures, if they wish to continue with the tire change (or investigate and rectify any problems with the PDS system (22)/TPMS systems). The invention further provides that the PDS system (22) will preferably log and retain a record of all TPMS data (e.g., within a database that is included within, or in communication with, the server (24)), for future access and evaluation.

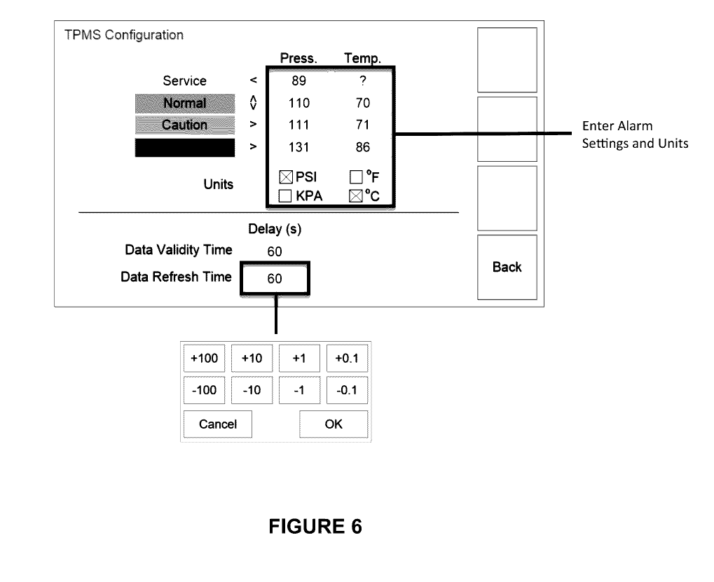

The invention provides that the establishment of TPMS settings is preferably reserved for only authorized operators, e.g., operators of the system who have been provided an authentication key, which must be provided to the system through the operators control panel (OCP) (18) by an operator before such settings may be established or altered. Upon operator authentication, the operators control panel (OCP) (18) may display a TPMS configuration page, in which TPMS settings may be entered or adjusted, as illustrated in FIG. 6.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A system for detecting and monitoring tire pressure and temperature during a tire repair or replacement procedure, and communicating a warning signal to a plurality of individuals upon the tire pressure or temperature exceeding a defined threshold, which comprises:
(a) a tire pressure monitoring system (TPMS) interface unit, which is configured to continually monitor temperature and pressure data associated with a tire being repaired or replaced, wherein such data are wirelessly collected from one or more sensors affixed to the tire being repaired or replaced;
(b) a proximity detection system (PDS) that is configured to detect and monitor a location of individuals who are wearing a personal proximity device (PPD); and
(c) a tire handler component that includes an omnidirectional head unit (OHU), which is configured to receive the temperature and pressure data from the tire pressure monitoring system (TPMS) interface unit and proximity information from the proximity detection system (PDS), wherein the tire handler component is configured to wirelessly communicate with each personal proximity device (PPD) to alert a person wearing such device (i) if they are within a defined radius of the tire handler component or (ii) if the temperature or pressure data associated with the tire being repaired or replaced falls within a defined warning range.

2. The system of claim 1, wherein the system is configured to issue at least three different signals to each personal proximity device, wherein a first signal indicates that tire pressure and temperature are within a pre-defined normal range; a second signal indicates that tire pressure and temperature are outside of a pre-defined normal range; and a third signal indicates that an individual wearing a personal proximity device is within a defined radius of the tire handler component.

3. The system of claim 2, wherein the system is further configured to provide a steady stream of feedback data, which informs an operator that the system is working and correctly monitoring the tire being repaired or replaced.

4. The system of claim 3, wherein:
(a) the proximity detection system (PDS) is configured to request the pressure and temperature data from the sensors, along with time and date stamp data; and
(b) the proximity detection system (PDS) is configured to compare the time and date stamp data to a real-time clock housed within the proximity detection system (PDS) and, if the time and date stamp data are within an acceptable pre-defined range from time data obtained from the real-time clock, the pressure and temperature data are displayed within a system interface and labeled as valid data.
